(19) United States
(12) Patent Application Publication
(10) Pub. No.: US 2010/0253153 A1
(43) Pub. Date: Oct. 7, 2010

(54) COIL UNIT AND ELECTRONIC INSTRUMENT

(75) Inventors: Yoichiro KONDO, Chino-shi (JP); Haruhiko SOGABE, Chino-shi (JP); Hirofumi OKADA, Suwa-shi (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/724,684

(22) Filed: Mar. 16, 2010

(30) Foreign Application Priority Data
Apr. 7, 2009 (JP) 2009-092820

(51) Int. Cl. H02J 17/00; H01F 27/28; H01F 27/08; H02J 7/00

(52) U.S. Cl. 307/104; 336/222; 336/61; 320/108

(57) ABSTRACT

To provide coil units, electronic instruments and the like, which can radiate heat generated in a coil into a space outside a protective member, while the number of components does not increase.

A coil unit 100 has a coil 110, and a protective member 120 that contacts a transmission surface of the coil 110 and covers at least the side of the transmission surface of the coil 110. The protective member 120 is composed of a resin material with an inorganic material added therein. The protective member 120 is also used as a heat radiation plate that dissipates heat generated in the coil 110 and radiates the heat.

The present application claims priority based on Japanese Patent Application 2009-092820 filed Apr. 7, 2009, and the application is herein incorporated in the present specification.

### TECHNICAL FIELD

The present invention relates to coil units and electronic instrument used for contactless power transmission and the like.

### TECHNOLOGICAL BACKGROUND

Contactless power transmission that uses electromagnetic induction to enable power transmission without contacts between metal portions is known. As application examples of this contactless power transmission, charging of portable telephones and charging household appliances (e.g., cordless telephone handsets), and the like have been proposed.

In contactless power transmission, the housing of each of a power transmission device and a power reception device is made of non-metal material such as plastics, such that a magnetic flux from a primary coil within the power transmission device can be effectively transmitted to a secondary coil within the power reception device. However, the non-metal material such as plastics is inferior in heat dissipating property, which leads to a problem in that heat generated within the power transmission device or the power reception device is difficult to be radiated externally from the housing, and temperatures of the components inside the device would rise.

Also, if the charge current is increased in an attempt to shorten the charging time, heat is generated in the coil during the charging, causing harmful influences such as a reduction in the coil performance and thus a reduction in the charging efficiency, heating of components around the coil and the like.

To solve the harmful influences accompanying the heat generation of the coil, technologies described, for example, in Patent Documents 1 and 2 have been proposed.

Patent Document 1 describes a coil unit having a planar coil (30), a magnetic member (52) provided below the planar coil (30), a magnetic flux leak prevention member (54) provided below the magnetic member (52), and a heat radiation plate 70 provided below the magnetic flux leak prevention member 52. By this, the magnetic member and the magnetic flux leak prevention member are interposed between the planar coil and the heat radiation plate, such that heat generated in the planar coil can be radiated by solid-to-solid heat dissipation. Also, because of the presence of the magnetic flux leak prevention member, it is possible to avoid generation of induction heating in the heat radiation plate that could be caused by the magnetic flux.

According to Patent Document 2, heat generated at the time of operation of a power transmission coil (101) is thermally transferred to a heat sink (97) through a first ceramics member (103) via a heat conductor (99). On the other hand, heat generated by a power reception coil (70) is thermally transferred to a heat spreader (63) through a second ceramics member (73) via a heat conductor (66).

### PRIOR ART TECHNOLOGY DOCUMENT

### Patent Document

[Patent Document 1] Published Laid-open Patent Application 2000-235860

[Patent Document 2] Published Patent 3821023

### SUMMARY OF THE INVENTION

### Problems to be Solved by the Invention

According to Patent Documents 1 and 2, although heat generated by the primary coil or the secondary coil can be radiated, many components are used, which leads to a higher cost of the coil unit. Also, according to Patent Documents 1 and 2, heat is escaped to the interior of the housing, which would leads to another problem in that heat is confined inside the devices.

According to some embodiments of the invention, it is possible to provide coil units, electronic instruments and the like which can radiate heat generated by a coil into a space outside a protective member while the number of components does not increase.

### Means to Solve the Problems

One embodiment of the present invention pertains to a coil unit having a coil, and a protective member that contacts a transmission surface of the coil and covers at least the side of the transmission surface of the coil, wherein the protective member is composed of a resin material with an inorganic material added therein.

According to one embodiment of the present invention, heat generated at the coil is transferred by the inorganic material included in the protective member on the side of the transmission surface of the coil, and radiated to an open air through the protective member. As the protective member is made of resin and thus has electric insulation property, it can be disposed on the side of the transmission surface of the coil without being magnetically coupled with the coil. As the protective member is also used as a heat radiation member, the number of components does not increase. In this manner, the inorganic member can have electric insulation property and thermal conductivity.

Here, the inorganic member may be made of metal oxide, such as, for example, alumina (AlO₃), silica (SiO₂) or the like. The inorganic member may have a multiple-particle structure, i.e., a structure in which very fine particles enter gaps among particles.

In accordance with an embodiment of the invention, the resin material may be thermoplastic. By so doing, a resin material with the inorganic member added as filler may be used, whereby the protective member can be formed by injection molding. The protective member can be formed into a shape that radiates heat generated in the coil.

In accordance with an embodiment of the invention, the protective member may functionally include a heat conduction section provided at least at a position opposite to the coil, and a heat radiation section provided on the outside of the heat conduction section. Heat generated at the coil at the time of energization of the coil can be conducted through the heat conduction section from the central side of the coil toward the peripheral side of the coil, and externally radiated by the heat radiation section.

In accordance with an embodiment of the present invention, the coil may have an air-core section, and the protective member may have a protruded portion that positions the air-core section. Alternatively, the protective member may have a storage section that stores the coil. Therefore, the coil can be positioned and retained at the protective member, and the contact area between the coil and the protective member is increased, whereby the heat radiation effect by the protective member can be increased.

In accordance with an embodiment of the invention, a magnetic body to be disposed on the side of a non-transmission surface of the coil may be further provided. By so doing, the magnetic body receives the magnetic flux of the coil, whereby the inductance can be increased. Also, the magnetic body can cover the storage section that stores the coil.

In accordance with an embodiment of the invention, the coil may include an inner end lead-out wire connected to an inner end of a coil wire wound in a spiral shape and an outer end lead-out wire connected to an outer end of the coil wire. In this case, the protective member may have a first storage section that stores the inner end lead-out wire and a second storage section that stores the outer end lead-out wire. By storing the inner end lead-out wire, the thickness of the coil unit can be reduced.

In accordance with an embodiment of the invention, the inner end lead-out wire may be lead out from the side of the transmission surface of the coil. The protective member is arranged at least on the side of the transmission surface, such that a storage section for storing the inner end lead-out wire lead out similarly from the side of the transmission surface can be provided by the protective member on the side of the transmission surface.

The coil may be surrounded by the protective member. By so doing, the contact surface between the coil and the protective member is further increased, such that the heat radiation effect by the protective member can be further improved. As an example, the protective member can be formed in one piece with the coil by injection molding with the coil inserted in an injection molding mold. In this case, the inner end lead-out wire that may be lead out along the non-transmission surface side of the coil can also be stored.

In accordance with an embodiment of the invention, the protective member may have a detection element storage section that stores a temperature detection element that detects a temperature elevation of the coil. The detection element storage section may be provided at a peripheral section of the coil, without being limited to a location at the air-core section of the coil. As the protective member has a heat dissipating function, the temperature is not required to be measured at the central position of the coil.

In accordance with an embodiment of the invention, concave and convex patterns may be formed on an outer surface of the protective member. The concave and convex patterns can increase the surface area for heat radiation, and reduce the contact surface with a counterpart instrument.

Another embodiment of the present invention defines an electronic instrument including the coil unit described above. The electronic instrument may be on a primary side or a secondary side of the contactless power transmission.

In accordance with another embodiment of the present invention, an outer surface of the protective member may be flush with an exterior surface of the housing of the electronic instrument. By so doing, a counterpart instrument to which power is transmitted in a contactless manner can be directly mounted on the protective member.

In accordance with another embodiment of the invention, the electronic instrument may be a power transmission device that transmits power through contactless power transmission to a power reception device, whereby the area of the protective member can be made greater than the contact surface between the power reception device to be mounted on the protective member and the protective member. By so doing, heat radiation can be effectively conducted at areas other than the portions contacting the power reception device.

In accordance with another embodiment of the invention, the protective member may be a portion of the housing of the electronic instrument, and the housing may be formed with the material of the protective member.

In accordance with another embodiment of the invention, the electronic instrument may be a power transmission device that transmits power to a power reception device through contactless power transmission, and the coil may be a primary coil, wherein the thickness of the protective member of the power transmission device may be made thicker than the thickness of a second protective member that covers a secondary coil provided at the power reception device, thereby improving the thermal conductivity.

### BRIEF DESCRIPTION OF THE DRAWINGS

FIG. 1 (A) and FIG. 1 (B) are views for explaining contactless power transmission.

FIG. 2 Cross-sectional view of a coil unit.

FIG. 3 Figure showing a state in which contactless power transmission is conducted between instruments on the primary and secondary sides, using the coil unit shown in FIG. 2 as the primary side.

FIG. 4 Cross-sectional view showing a modified example of the coil unit.

FIG. 5 Cross-sectional view showing another modified example of the coil unit.

FIG. 6 Plan view of a planar air-core coil.

FIG. 7 (A) is a plan view of still another modified example of the coil unit, and FIG. 7 (B) is a cross-sectional view thereof.

FIG. 8 Figure showing individual forming and insert forming of a coil and a protection sheet.

FIG. 9 Partially cut-out figure showing a protective member made by insert forming.

FIG. 10 Figure of a coil unit having a section for storing a temperature detection element in an air core section thereof.

FIG. 11 Figure of a coil unit having a section for storing a temperature detection element in a peripheral section of the coil.

FIG. 12 Figure showing a modified example of a coil unit having a concave-convex pattern on an external surface of the protective member.

FIG. 13 Figure showing a coil unit in which an external surface of the protective member is level with the surface of the housing of the electronic instrument.

FIG. 14 Figure showing a coil unit in a type different from that in FIG. 1 (B).

### EMBODIMENTS OF THE INVENTION

Preferred embodiments of the present invention will be described below. It is noted that the embodiments to be described below would not unduly limit the contents of the present invention recited in the scope of patent claims, and all compositions described in the present embodiments would not necessarily be indispensable as means for solution given by the present invention.

1. Electronic Instrument

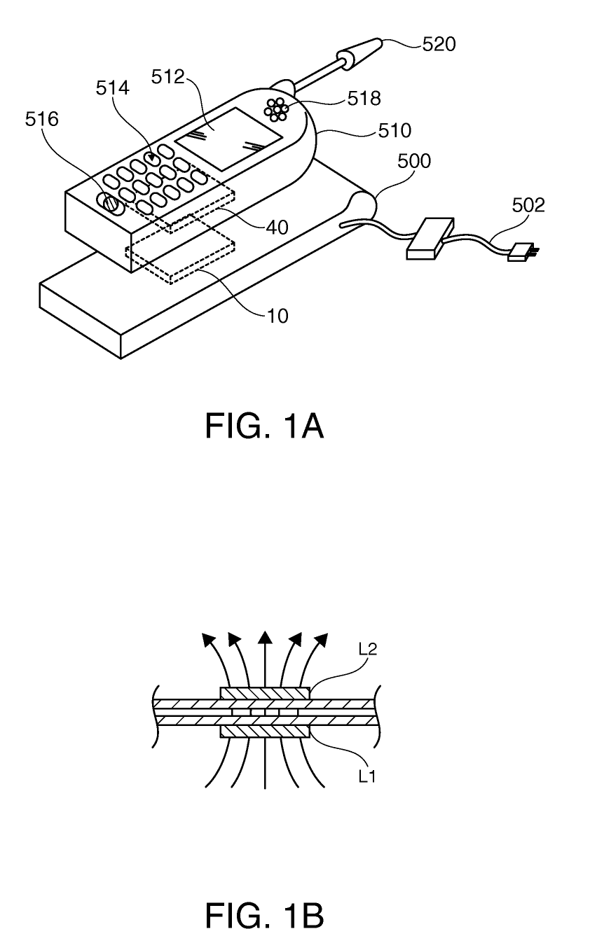

FIG. 1 (A) shows an example of an electronic instrument to which a contactless power transmission method in accordance with an embodiment is applied. A charger 500 (cradle), one of electronic instruments on the power transmission side, has a power transmission device 10. A portable telephone 510, one of electronic instruments on the power reception side, has a power reception device 40. Also, the portable telephone 510 includes a display section 512 such as an LCD, an operation section 514 composed of buttons and the like, a microphone 516 (a sound input section), and a speaker 518 (a sound output section), and an antenna 520.

Electrical power is supplied to the charger 500 through an AC adaptor 502, and the electrical power is transmitted through contactless power transmission from the power transmission device 10 to the power reception device 40. By this, a battery in the portable telephone 510 is electrically charged, and devices within the portable telephone 510 can be operated.

It is noted that the electronic instrument on the power reception side in accordance with the present embodiment is not limited to the portable telephone 510. For example, it can be applied to a variety of electronic instruments, such as, for example, a wrist watch, a cordless telephone, a shaver, an electric tooth brush, a wrist-wearable computer, a handy terminal, a portable information terminal, an electric bicycle, an IC card and the like.

As schematically shown in FIG. 1 (B), power transmission from the power transmission device 10 to the power reception device 40 is realized by electromagnetically coupling a primary coil L1 (a power transmission coil) provided on the side of the power transmission device 10 with a secondary coil L21 (a power reception coil) provided on the side of the power reception device 40, thereby forming a power transmission transducer. This makes contactless power transmission possible.

2. Coil Unit

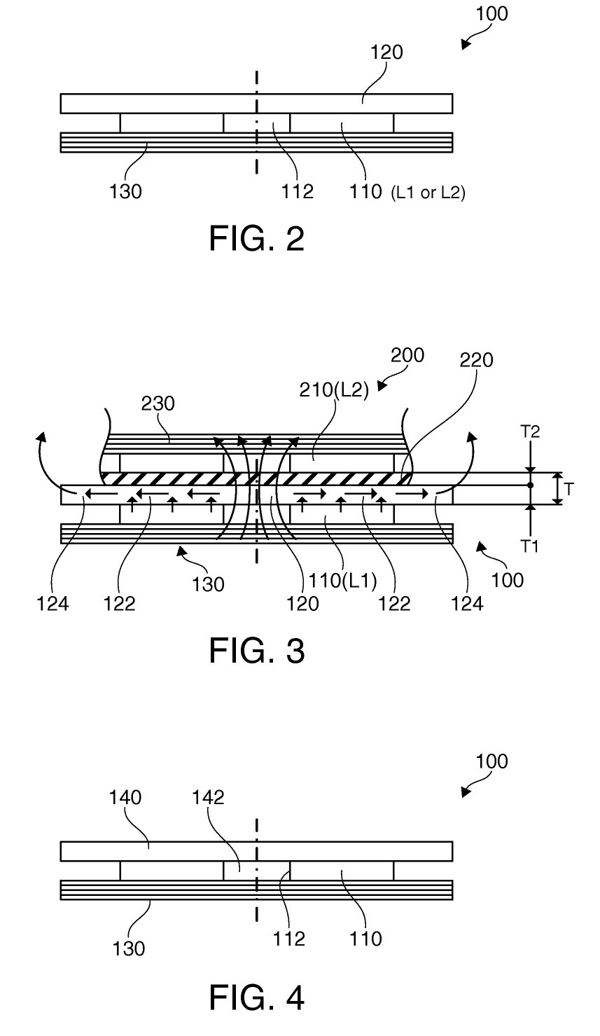

FIG. 2 shows a coil unit 100 that is provided on the power transmission device 10 and/or the power reception device 40. Here, it will be described as a primary coil unit 100 to be provided on the power transmission device 10, but a secondary coil unit to be provided on the power reception device 40 can be composed in a similar manner.

The coil unit 100 has a coil 110 that may be the primary coil L1 or the secondary coil L2, and a protective cover (a protective member in a broad sense) 120 that is in contact with a transmission surface of the coil 110, and covers at least the side of the transmission surface of the coil 100. The coil 110 may be a planar air-core coil formed from a coil wire that is wound in a spiral shape in a plane, and has an air-core section 112, as shown in FIG. 2. A magnetic body, such as, a magnetic sheet 130 may be provided on a non-transmission surface side of the planar air-core coil 110. The magnetic sheet 130 functions to receive a magnetic flux, and has a function to increase the inductance. As the material of the magnetic sheet 130, soft magnetic material may be preferred, and ferrite soft magnetic material or metal soft magnetic material may be used.

The non-transmission surface of the coil 110 may be provided with, for example, a double-sided adhesive tape, such that the magnetic sheet 130 can be adhered thereto through the double-sided adhesive tape. However, a double-sided adhesive tape or the like may not preferably be provided between the transmission surface of the coil 110 and the protective cover 120. As described below, the protective cover 120 functions as a heat radiation plate that dissipates heat of the coil 110 and radiates the heat. Accordingly, in the structure shown in FIG. 3, the protective cover 120 and the magnetic sheet 130 may be adhered by a double-sided tape on the outside of the coil 110.

The protective cover 120 is an injection-molded part that is formed by injection-molding thermoplastic resin with inorganic material having electric insulation property and heat dissipation property filled therein as inorganic filler, and can also be used as a heat radiation plate. As the inorganic material, inorganic particles may be used and, for example, metal oxides, such as, for example, alumina (AlO₃), silica (SiO₂) or the like may be used. Depending on the filling amount of the inorganic filler, the thermal conductivity can be adjusted in a range between, for example, 2.0 and 18.0 W/m·K. In order to increase the thermal conductivity, the inorganic filler may preferably have a multi-particle structure and, for example, may have a structure in which very fine particles of about 0.5 μm in diameter enter gaps among particles of about 1-40 μm in diameter. As the material of the protective cover 120, for example, a product “Zima-Inus” manufactured by Sumitomo Osaka Cement Co., Ltd. may be used.

FIG. 3 shows a state in which contactless power transmission is conducted while a secondary side coil unit 200 is mounted on a primary side coil unit 100. The secondary side coil unit 200 has a coil 210 that functions as the secondary side coil L2; a lower surface of the coil 210 is covered by a protective cover 220; and a magnetic body, for example, a magnetic sheet 230 is provided on an upper surface of the coil 210. It is noted that the protective cover 220 on the secondary side shown in FIG. 4 can be made of the same material as that of a primary side protective cover 120, but it is made of an ordinary thermoplastic resin in accordance with the present embodiment, and has a substantially lower thermal conductivity than that of the protective cover 120 on the primary side. Further, a power reception device (for example, a portable telephone) including the secondary side coil unit 200 is placed on the protective cover 120, and the protective cover 120 has a greater area than the contact surface thereof with the power reception device.

In FIG. 3, the primary coil 110 and the secondary coil 210 are electromagnetically coupled, whereby electrical power can be transmitted in a contactless manner from the primary side toward the secondary side. Here, upon energizing the primary coil 110, the primary coil 110 generates heat. The heat generated in the primary coil 110 is dissipated by solid-to-solid heat transfer through an interface between the coil 110 and the protective cover 120 to the protective cover 120. This is because the protective cover 120 has a higher thermal conductivity than those of the magnetic sheet 130 that is in contact with the coil 110 or air atmosphere.

The heat transferred to the protective cover 120 is dissipated through a medium with the lowest thermal conductivity. The secondary side protective cover 220 that is in contact with the primary side protective cover 120 is made of resin, and therefore its thermal conductivity is low. For this reason, the heat transferred to the protective cover 120 mainly dissipates within the protective cover 120 and is transferred from the central side of the coil 110 toward the peripheral side. The heat, transferred to a region in the peripheral portion of the primary side protective cover 120, and where the primary side protective cover 120 becomes non-contact with the secondary side protective cover 220, is radiated into the open air. It is noted that heat moves toward a lower temperature side, such that the heat is radiated to the open air that is at a lower temperature than the interior of the primary side protective cover.

Roughly describing, the protective cover 120 functionally includes, as shown in the figure, a heat conduction section 122 provided at least at a position opposite to the coil 110, and a heat radiation section 124 provided outside the heat conduction section 122. In other words, the protective cover 120 is also used as a heat radiation plate.

During a contactless power transmission period, the above-described heat dissipation and heat radiation operations are repeated, whereby, as the temperature of the heat radiation section 124 lowers, the heat dissipates in the heat conduction section 122 of the protective cover 120 from its central portion at higher temperatures to its peripheral portions at lower temperatures, such that the heat of the coil 110 can be effectively radiated into the open air.

As shown in FIG. 3, when the thickness of the primary side protective cover 120 is T1, and the thickness of the secondary side protective cover 220 is T2, the total thickness T=T1+T2. The total thickness T defines a gap between the primary side coil 110 and the secondary side coil 210. The smaller the gap T, the better the efficiency in contactless power transmission becomes, and for example, it could be about 3 mm. Therefore, the thickness T1 of the primary side protective cover 120 and the thickness T2 of the secondary side protective cover 220 need to be thin. However, the greater the thickness T1 of the primary side protective cover 120, the better the heat dissipation property would become.

In general, the thickness T1 and T2 of the injection-molded protective covers 120 and 220 is preferably thinner but needs to be at least about 1 mm to maintain the quality as an injection molded product. Therefore, it would be preferable if T1>T2 within a range in which the injection molded product quality of the protective cover 120 can be maintained, for example, T2=2 mm and T2=1 mm, rather than T1=T2=T/2, in view of increasing the heat dissipation property of the primary side protective cover 120.

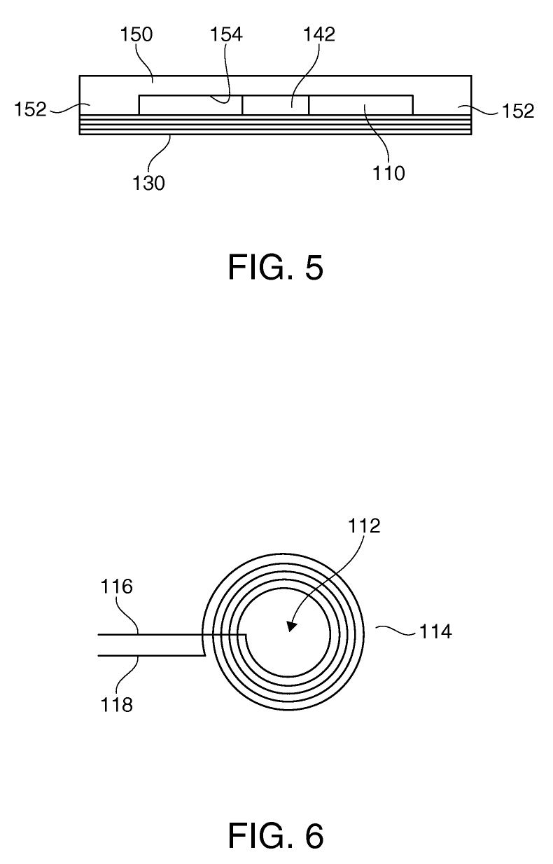

FIG. 4 shows a modified example of the protective cover. A protective cover 140 shown in FIG. 5 has a protruded section 142 that is to be inserted in the air-core section 112 of the coil 110. The protruded section 142 allows the coil 110 to be positioned on the protective cover 140, which improves the assemblability.

FIG. 5 shows still another modified example of the protective cover. A protective cover 150 shown in FIG. 5 has a circumferential wall 152 for forming a storage section, for example, a concave portion 154, for storing the coil 110, in addition to the protruded section 142 described above. In this case, the magnetic body 130 functions as a lid for the storage section 154 that stores the coil 110. In this instance, the magnetic body 130 is bonded at least to the circumferential wall 152.

The structure shown in FIG. 5 provides improved assemblability over the structure shown in FIG. 3. Also, in the structures shown in FIG. 4 and FIG. 5, as compared to the structure shown in FIG. 3, the contact portion of the protective cover 140 or 150 with respect to the coil 110 is given not only by the transmission surface of the coil 110, but also is expanded to the inner periphery and the outer periphery of the coil 110, whereby the contact area with the coil 110 increases and the heat dissipation property improves.

FIG. 6 is a plan view showing an example of the air-core coil 110. The air-core coil 110 includes an inner end lead-out wire 116 that is connected to an inner end of the coil wire 114 that is wound in a spiral shape, and an outer end lead-out wire 118 that is connected to an external end of the coil wire 114.

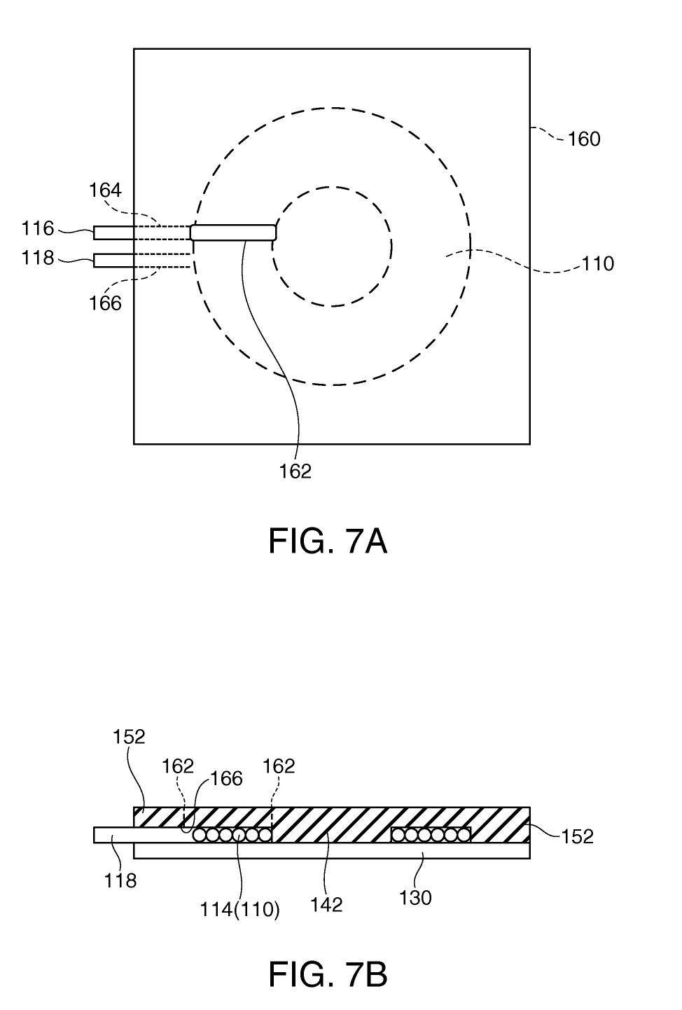

FIGS. 7 (A) and (B) show a protective cover 160 equipped with storage sections for an inner end lead-out wire 116 and an external end lead-out wire 118. The protective cover 160 has first storage sections 162 and 164 for storing the inner end lead-out wire 116, and a second storage section 166 for storing the external end lead-out wire 118. Here, the inner end lead-out wire 116 is lead out along the transmission surface side of the coil 110. By storing the inner end lead-out wire 116, the thickness of the coil unit 100 can be reduced.

Among the first storage sections 162 and 164, one of the storage sections 162 is formed by, for example, an elongated through-hole, which stores a portion of the inner end lead-out wire 116 that is lead out along the transmission surface side of the coil 110. As the inner end lead-out wire is exposed outside by the through-hole 162, a tape-like protective sheet may be provided to cover the through-hole 162. It is noted that, if the thickness T1 of the protective cover 160 (see FIG. 3) is two times the coil wire 114 or more, the storage section 162 may be made of a groove instead of the through-hole.

The other of the storage sections 164 among the first storage sections 162 and 164, and the second storage section 166 are grooves formed at positions indicated in FIG. 7 (A). The second storage section 166 is shown in a cross-sectional view in FIG. 7 (B).

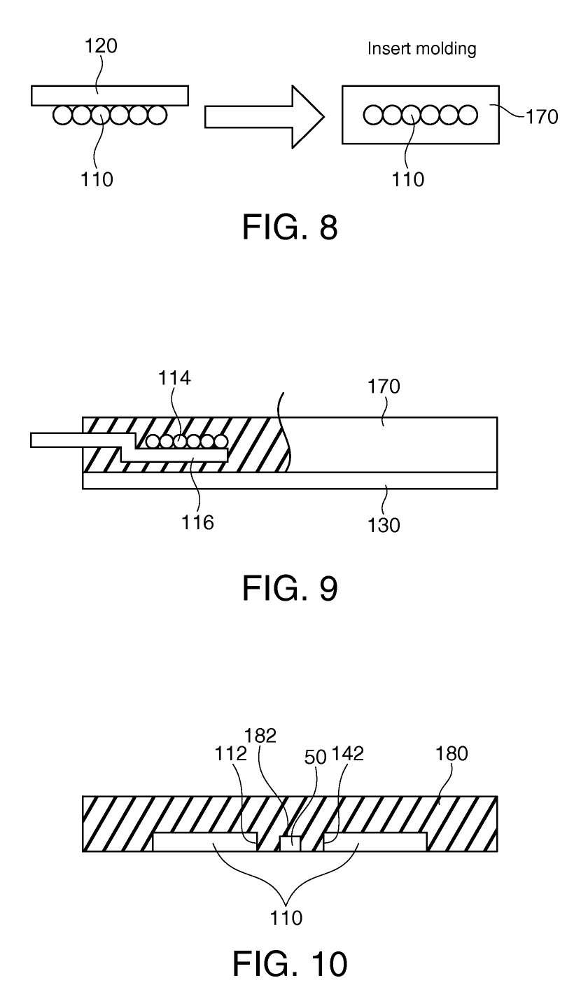

The protective cover 140, 150 or 160 shown in FIG. 4, FIG. 5 or FIGS. 8 (A) and (B) may be formed in one piece with the coil 110 by injection molding while the coil 110 is inserted in an injection molding mold. By so doing, the coherency between the coil 110 and the protective cover 140, 150 or 160 is increased, whereby the heat dissipation property by the protective cover 140, 150 or 160 can further be improved.

In the insert forming in which a protective cover and a coil are formed in one piece, starting from a configuration in which the protective cover 120 is in contact with the coil 110 on its transmission surface side, as shown on the left side in FIG. 8, it is possible to form a protective cover 170 which entirely covers the circumference of the coil 110 including the transmission surface and non-transmission surface of the coil 110 and adheres to the coil 110. In such insert forming, the contact area between the coil 110 and the protective cover 170 is further increased, such that the heat dissipation property is further improved by the protective cover 170. In this case, as shown in FIG. 9, the inner end lead-out wire 116 can be lead out along the non-transmission surface side of the coil 110 (on the side of the magnetic sheet 130), unlike FIG. 7 (B).

It is noted that, in the insert forming shown on the right side of FIG. 8, the coil 110 needs to be retained within a cavity of the injection molding mold, and the inner end and external end lead-out wires 116 and 118 can be used for retaining the coil 110. To arrange the coil 110 in a more stable manner, the coil 110 may be supported by a plurality of pins, which may require to form apertures in the protective cover at positions corresponding to the positions of the pins. It is noted that the coil 110 and the magnetic sheet 130 may be disposed in a metal mold, and can be formed in one piece with the protective cover.

The protective cover may have a detection element storage section that stores a temperature detection element for detecting a temperature elevation in the coil 110. If a metal foreign object is present between the primary side protective cover 120 and the secondary side protective cover 220 shown in FIG. 3, the primary coil 110 is magnetically coupled with the metal foreign object, whereby an eddy current is generated in the metal foreign object, thereby generating heat, causing an abnormal temperature. The abnormal temperature needs to be detected, and the energization of the primary side coil 110 needs to be stopped.

FIG. 10 shows a protective cover 180 having a detection element storage section 182 that stores a temperature detection element 50, formed in a protruded section 142 that is to be inserted in the air-core section 112 of the coil 110. By the presence of a foreign object, the temperature at the center of the coil 110 elevates most, such that the temperature detection element 50 can detect such temperature elevation.

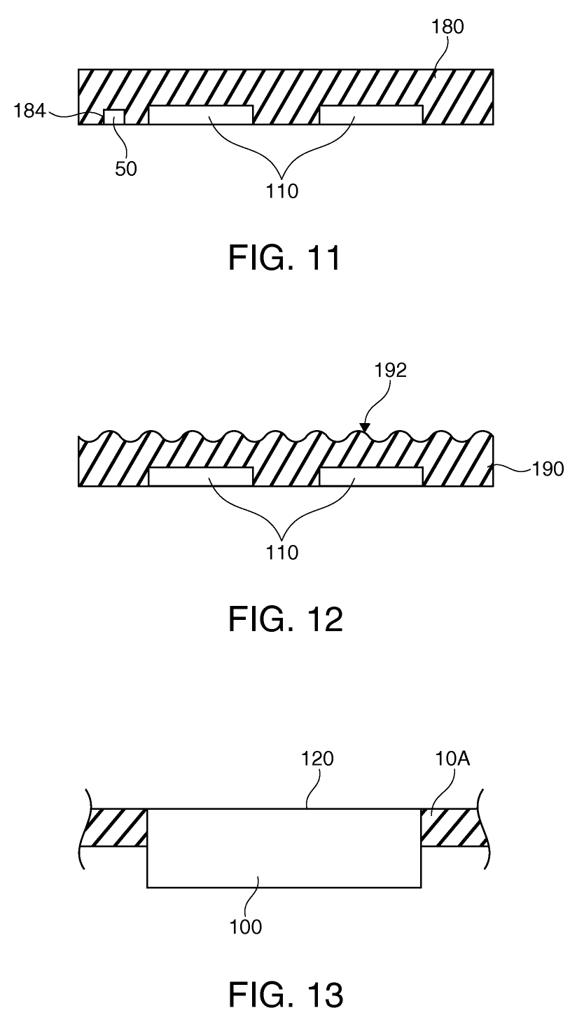

The protective cover 180 exceeds in heat dissipation property, such that a detection element storage section 184 may be provided at the periphery of the coil 110, as shown in FIG. 11, without being limited to detecting temperatures at the center of the coil 110. In FIG. 11, the detection element storage section 184 is provided in the circumferential wall 152 that stores the coil 110. By so doing, a temperature detection element 50 does not have to be disposed at the air-core section 112 of the coil 110 where the magnetic flux density is high.

FIG. 12 shows a protective cover 190 with concave-convex patterns 192 formed in its surface. The concave-convex patterns 192 are an example of increasing the surface area of the protective cover 190, and may be, for example, matte fine concave-convex patterns. The concave-convex patterns 192 play two roles as the heat radiation function. One of them is to increase the surface area of the protective cover 190, thereby increasing the heat radiation area. The other is to provide the mounting surface of the secondary side instrument with the concave-convex patterns 192, thereby reducing the contact area with the secondary side instrument, whereby solid-to-solid heat conduction between the secondary side instrument and the protective cover can be reduced. By this, heat dissipation from the primary coil to the secondary side instrument can be suppressed.

FIG. 13 shows a relation between the coil unit 100 and a housing 10A of a primary side instrument 10. The external surface of the protective cover 120 (140, 150, 160, 170, 180 or 190) is flush with the external surface of the housing 10A of the electronic instrument 10 in which the coil unit 100 is provided. By this, as shown in FIG. 4, the secondary side instrument can be directly placed on the protective cover 120 to perform contactless power transmission. It is noted that the housing 10A of the primary side instrument 10 may be made of the material of the protective cover 120. In other words, the coil 110 is mounted on the housing 10A of the primary side instrument.

The embodiments of the invention are described above in detail. However, those skilled in the art should readily understand that many modifications can be made without departing in substance from the novel matter and effects of the invention. Accordingly, those modified examples are deemed to be included in the scope of the present invention. For example, throughout the specification and the drawings, terms described at least once with different terms that are in a broader sense or synonymous can be replaced with these different terms in any sections of the specification and the drawings. Also, combinations of any and all of the embodiments and the modified examples are included in the scope of the present invention.

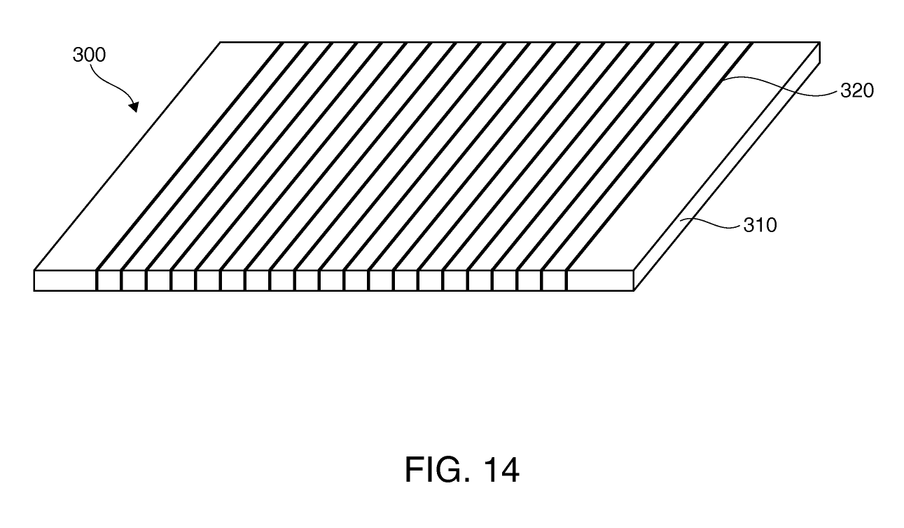

Coils to which the present invention is applicable are not limited to the planar air-core coil described above. FIG. 14 shows a coil unit 300 of a type different from the embodiments described above. The coil unit 300 is formed with a plate-like magnetic core 310 having a coil wire 320 wounded thereon. When an AC current is circulated in the coil wire 320 of the coil unit 300, a magnetic path is formed in the magnetic core 310, and a magnetic flux is also formed in parallel with the magnetic core 310. Even when this coil unit 300 may be used as the primary coil L1, contactless power transmission is possible through magnetic coupling with the secondary coil L2. Further, a protective cover described above may be arranged at least on the transmission surface side of the coil in the coil unit 300.

In other words, the present invention is applicable not only to those having a magnetic body on one surface of the coil, but also to those that use a magnetic body as a core. Combinations of a coil and a magnetic body forming a magnetic path of the coil are not limited to these described above, and coils and magnetic bodies in a variety of other configurations may be combined, and they may not necessarily be planar thin coil units.

1. A coil unit comprising:
a coil; and
a protective member that contacts a transmission surface of the coil and covers at least the side of the transmission surface of the coil,
the protective member being composed of a resin material with an inorganic material added therein.

2. A coil unit according to claim 1, the inorganic member being made of metal oxide.

3. A coil unit according to claim 1, the resin material being thermoplastic.

4. A coil unit according to claim 1, the protective member radiating heat generated at the coil.

5. A coil unit according to claim 1, the protective member including a heat conduction section provided at least at a position opposite to the coil, and a heat radiation section provided on the outside of the heat conduction section, heat generated in the coil at the time of energization of the coil being conducted through the heat conduction section from the central side of the coil toward the peripheral side of the coil, and the heat generated in the coil radiating outside by the heat radiation section.

6. A coil unit according to claim 1, the coil having an air-core section, and the protective member having a protruded section that positions the air-core section.

7. A coil unit according to claim 1, the protective member having a storage section that stores the coil.

8. A coil unit according to claim 7, further comprising a magnetic body to be disposed on the side of a non-transmission surface of the coil, the magnetic body covering the storage section.

9. A coil unit according to claim 1,
the coil including an inner end lead-out wire connected to an inner end of a coil wire wound in a spiral shape and an outer end lead-out wire connected to an outer end of the coil wire, and
the protective member having a first storage section that stores the inner end lead-out wire and a second storage section that stores the outer end lead-out wire.

10. A coil unit according to claim 9, the inner end lead-out wire being lead out from the side of the transmission surface of the coil.

11. A coil unit according to claim 1, the coil being surrounded by the protective member.

12. A coil unit according to claim 11,
the coil including an inner end lead-out wire connected to an inner end of a coil wire wound in a spiral shape and an outer end lead-out wire connected to an outer end of the coil wire,
the protective member having a first storage section that stores the inner end lead-out wire and a second storage section that stores the outer end lead-out wire, and
the inner end lead-out wire being lead out from the side of the non-transmission surface side of the coil.

13. A coil unit according to claim 1, the protective member having a detection element storage section that stores a temperature detection element that detects a temperature elevation of the coil.

14. A coil unit according to claim 1, concave and convex patterns being formed on an outer surface of the protective member.

15. An electronic instrument comprising the coil unit recited in claim 1.

16. An electronic instrument according to claim 15, an outer surface of the protective member being flush with an exterior surface of a housing of the electronic instrument.

17. An electronic instrument according to claim 15, the electronic instrument being a power transmission device that transmits power through contactless power transmission to a power reception device, an area of the protective member being greater than an area of the contact surface between the power reception device to be mounted on the protective member and the protective member.

18. An electronic instrument according to claim 15, the protective member being a portion of the housing of the electronic instrument.

19. An electronic instrument according to claim 15, the electronic instrument being a power transmission device that transmits power to a power reception device through contactless power transmission, and the coil is a primary coil,
the thickness of the protective member of the power transmission device being thicker than the thickness of a second protective member that covers a secondary coil provided at the power reception device.
